(19) United States
(12) Patent Application Publication
(10) Pub. No.: US 2013/0133487 A1
(43) Pub. Date: May 30, 2013

(54) Tool Head Structure

(71) Applicant: Yang-Ming HSU, Changhua County (TW)

(72) Inventor: Yang-Ming HSU, Changhua County (TW)

(21) Appl. No.: 13/304,614

(22) Filed: Nov. 25, 2011

(51) Int. Cl. B25B 15/00

(52) U.S. Cl. 81/436

(57) ABSTRACT

A tool head structure includes a body and an assistant rotary member pivotally mounted on a drive end of the body in an eccentric manner. When the tool head is inserted in a worn out hole, and the user rotates the tool head, the assistant rotary member will be pivoted into an eccentric position with respect to the drive end of the body, so that the contacting area of the tool head for contacting the worn out hole is increased, which makes the tool head of the present invention more applicable to the worn out hole as compared to conventional ordinary tool head.

### BACKGROUND OF THE INVENTION

1. Field of the Invention

The present invention relates to a hand tool, and more particularly to a tool head structure of a hand tool.

2. Description of the Prior Art

Conventional hand tools, such as the screwdriver head as shown in FIGS. 1 and 2, can only be used in cooperation with the tool whose drive hole A must be formed corresponding to the shape of the cross section of the screwdriver head. Further, both the screwdriver head 10 and the drive hole A of the tool for engaging with the screwdriver head 10 will wear off after some time, or even worse that the screwdriver head 10 and the drive hole A are likely to break if the screwdriver head 10 is used in cooperation with a tool whose drive hole A does not fit the size of the screwdriver head 10.

The present invention has arisen to mitigate and/or obviate the afore-described disadvantages.

### SUMMARY OF THE INVENTION

The primary object of the present invention is to provide a tool head structure which is capable of rotating a worn out drive hole by increasing the contacting area of the tool head for contacting the drive hole.

To achieve the above object, a tool head structure in accordance with the present invention comprises a body and an assistant rotary member pivotally mounted on a drive end of the body in an eccentric manner. When the tool head is inserted in a worn out hole, and the user rotates the tool head, the assistant rotary member will be pivoted into an eccentric position with respect to the drive end of the body, so that the contacting area of the tool head for contacting the worn out hole is increased, which makes the tool head of the present invention more applicable to the worn out hole as compared to conventional ordinary tool head.

### BRIEF DESCRIPTION OF THE DRAWINGS

FIG. 1 shows a conventional screwdriver head;

FIG. 2 is an illustrative view showing that the conventional screwdriver head is used to rotate a worn out hole;

FIG. 3 is an exploded view of a tool head structure in accordance with the present invention;

FIG. 4 is an assembly perspective view of the tool head structure in accordance with the present invention;

FIG. 5 shows the drive end of the tool head structure in accordance with the present invention;

FIG. 6 shows that the assistant rotary member is pivoted into an eccentric position with respect to the drive end of the tool head structure in accordance with the present invention;

FIG. 7 is an illustrative view showing that the tool head structure in accordance with the present invention is used to rotate a worn out hole; and

FIG. 8 shows another embodiment of the tool head structure in accordance with the present invention.

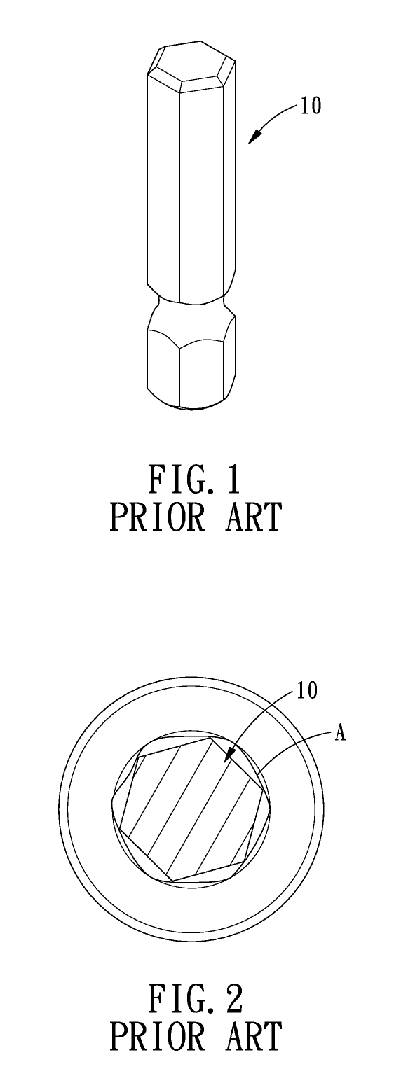

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

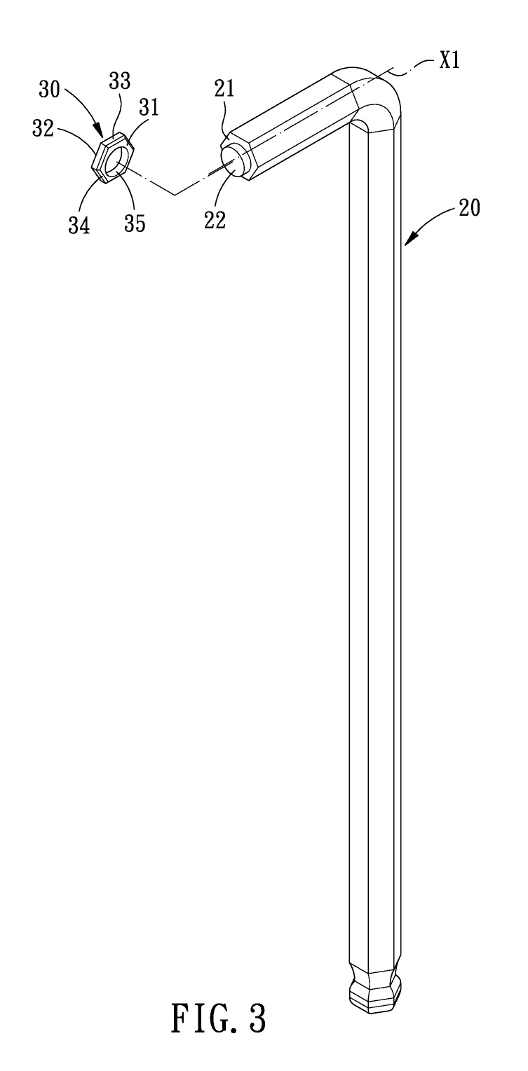

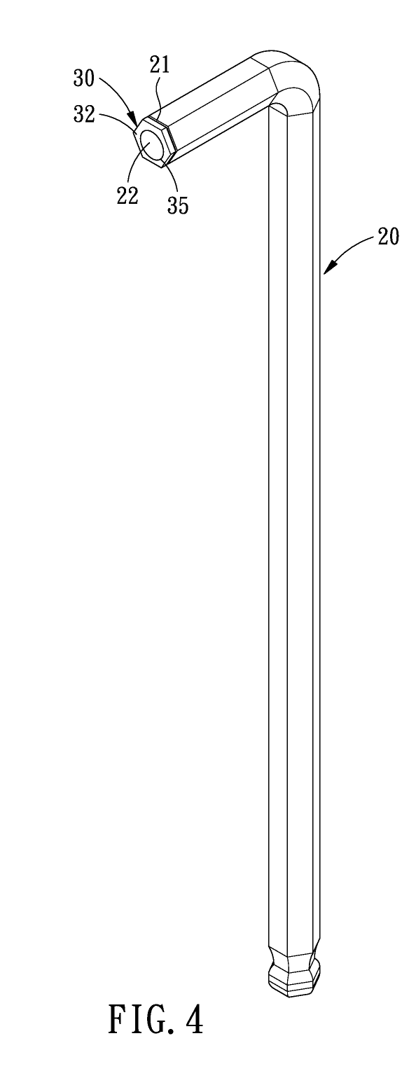

Referring to FIGS. 3-8, a tool head with an improved head in accordance with the present invention comprises: a body 20 and an assistant rotary member 30.

The body 20 includes a central axis X1, at one end of the body 20 of the tool is a drive end 21 which is hexagonal shaped in cross section in this embodiment. The drive end 21 includes a central point X2 which is located on the central axis X1. The drive end 21 extends outward to form a connecting portion 22. The connecting portion 22 in this embodiment is a cylinder structure and has a central point X3 which is eccentric with respect to the central point X2 of the drive end 21.

The assistant rotary member 30 includes a first side 31, a second side 32 and a flange 33 therebetween. Between the first side 31 and the flange 33 is formed a plurality of cutting surfaces 34. The assistant rotary member 30 is formed in the shape of the drive end 21 of the tool head and formed with a connecting hole 35 which has a central point X4. The assistant rotary member 30 is pivotally mounted on the connecting portion 22 of the body 20 via the connecting hole 35 in such a manner that the central point X4 of the connecting hole 35 is aligned with the central point X3 of the connecting portion 22 are aligned, and the first side 31 of the assistant rotary member 30 is abutted against the body 20.

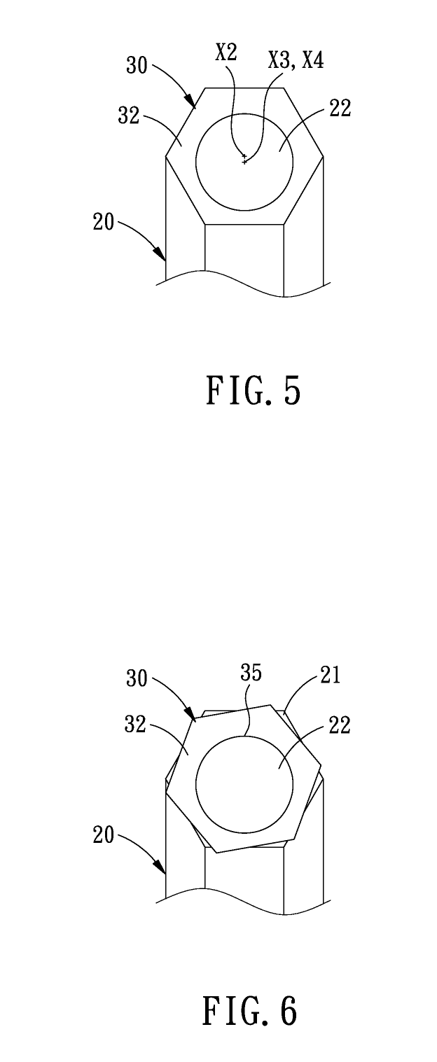

When the tool head is not in use, the assistant rotary member 30 is fully aligned with the drive end 21 of the body 20, as shown in FIG. 5, at this moment, the tool head can be used as an ordinary tool head to engage with a corresponding sized drive hole (of a tool).

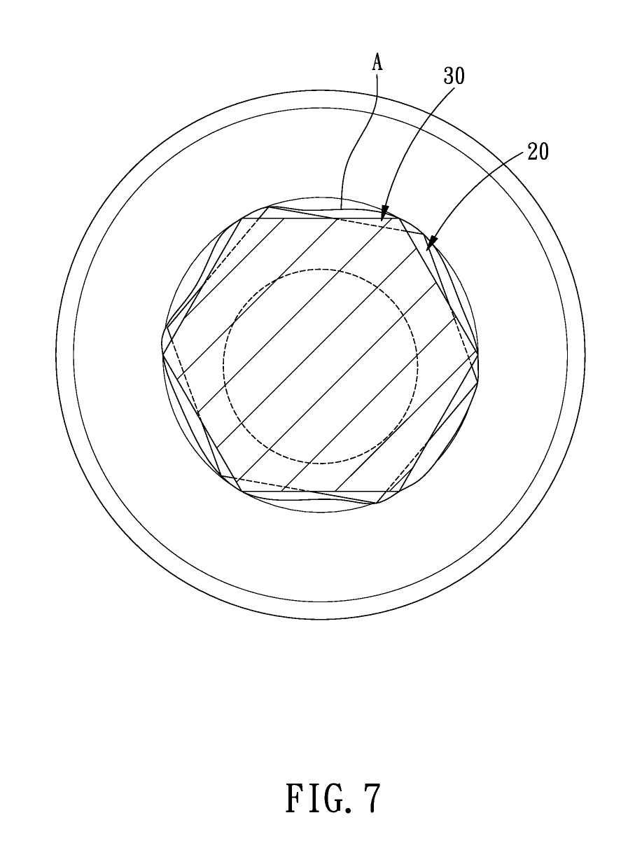

The tool head of the present invention can also be used to engage with a worn out (broken) hole A. Slip will occur when an ordinary tool head is engaged in a worn out hole to perform rotation. However, when the tool head of the present invention is inserted in a worn out hole A, and the user rotates the tool head, the assistant rotary member 30 will be pivoted with respect to the body 20 and pivoted into an eccentric position with respect to the drive end 21 of the body 20 due to the assistant rotary member 30 is connected on the connecting portion 22 of the body 20 in an eccentric manner, as shown in FIGS. 6 and 7, so that the assistant rotary member 30 and the drive end 21 are all in contact with the inner surface of the worn out hole A, namely, the contacting area of the tool head for contacting the worn out hole A is increased, which makes the tool head of the present invention more applicable to the worn out hole A as compared to conventional ordinary tool head.

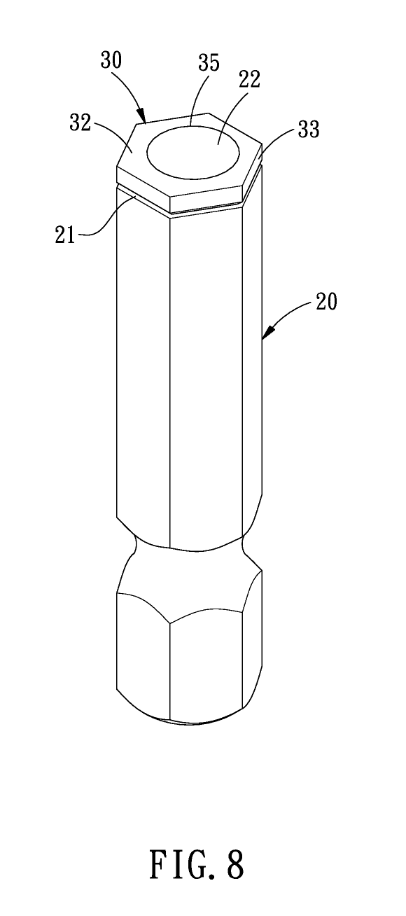

Moreover, the assistant rotary member 30 is arranged with its first side 31 abutting against the body 20 of the tool head, and the first side 31 is formed with the cutting faces 34, the cutting faces 34 can prevent assembly interference and make assembly easier. The abovementioned body 20 of the tool head is a hexagonal wrench and can also be in other forms, such as the screwdriver head as shown in FIG. 8.

While we have shown and described various embodiments in accordance with the present invention, it is clear to those skilled in the art that further embodiments may be made without departing from the scope of the present invention.

What is claimed is:

1. A tool head structure comprising:
a body including a central axis, one end of the body of the tool being a drive end, the drive end having a central point located on the central axis, the drive end extending outward to form a connecting portion which has a central point being eccentric with respect to the central point of the drive end; and
an assistant rotary member formed with a connecting hole which has a central point, the assistant rotary member being pivotally mounted on the connecting portion of the body via the connecting hole in such a manner that the central point of the connecting hole is aligned with the central point of the connecting portion are aligned.

2. The tool head structure as claimed in claim 1, wherein the drive end is a hexagonal in cross section, and the connecting portion is a cylinder.

3. The tool head structure as claimed in claim 1, wherein the assistant rotary member includes a first side, a second side and a flange therebetween, between the first side and the flange is formed a plurality of cutting surfaces, and the first side of the assistant rotary member is abutted against the body.

4. The tool head structure as claimed in claim 1, wherein the assistant rotary member is formed in the shape of the drive end.
